(19) United States
(12) Patent Application Publication
(10) Pub. No.: US 2015/0111056 A1
(43) Pub. Date: Apr. 23, 2015

(54) LIGNOCELLULOSE PRESERVATIVE COMPOSITION, PROCESS USING SUCH COMPOSITION, PRESERVED LIGNOCELLULOSIC MATERIAL OBTAINABLE BY SUCH PROCESS AND PRODUCT COMPRISING SUCH MATERIAL

(71) Applicant: Stichting Dienst Landbouwkundig Onderzoek, Wageningen (NL)

(72) Inventors: Richard Johannes Antonius Gosselink, Zelhem (NL); Jan Evert Gerard Van Dam, Wageningen (NL); Wouter Teunissen, Ede (NL)

(73) Assignee: Stichting Dienst Landbouwkundig Onderzoek, Wageningen (NL)

(21) Appl. No.: 14/404,434

(22) PCT Filed: May 28, 2013
(86) PCT No.: PCT/NL2013/050385

§ 371 Date: Nov. 26, 2014

(30) Foreign Application Priority Data
May 31, 2012 (EP) 12170192.4

(51) Int. Cl. B27K 3/50; B27K 5/00

(52) U.S. Cl. CPC B27K 3/50; B27K 5/001; B27K 2240/70
USPC 428/541; 524/78; 264/257

(57) ABSTRACT

The invention relates to a lignocellulose preservative composition comprising in the range of from 50 to 98 wt % of a pyrolysis oil obtainable by pyrolysis of lignocellulosic material, a polymerisable furan compound and a catalyst for polymerising the furan compound in a catalytically effective amount. The invention further relates to a process for producing preserved lignocellulosic material comprising impregnating lignocellulosic material by immersion in such composition and subsequently curing the impregnated material and to preserved lignocellulosic material obtainable by such process and to an engineered wood or non-wood product comprising such lignocellulosic material.

### FIELD OF THE INVENTION

The present invention relates to a lignocellulose preservative composition, a process for producing preserved lignocellulosic material using such composition, preserved lignocellulosic material obtainable by such process and engineered wood or non-wood product comprising such lignocellulosic material.

### BACKGROUND OF THE INVENTION

Conventional wood preservatives such as creosote oil, Wolman salts or pentachlorophenol are known to have adverse effects on the environment and its use is therefore prohibited or bound to restrictions in many countries. Alternative preservatives which are environmentally safe are therefore needed.

Fast pyrolysis oil has been proposed as wood preservative. In WO 00/025996 for example is disclosed a wood preservative composition that comprises fast pyrolysis oil, preferably in combination with a further conventional preservative such as creosote or pentachlorophenol. A disadvantage of the wood preservative composition with further conventional preservatives of WO 00/025996 is that it still comprises environmentally unfriendly components. A disadvantage of the use of pyrolysis oil as such is that it leads to an unpleasant odour of the treated wood. Moreover, leaching of pyrolysis oil from the treated wood occurs.

In WO 02/30638 is mentioned that dimension stability and rot resistance of wood can be improved by impregnating wood with a solution containing a polymerisable furfuryl alcohol monomer and an anhydride or acid. In order to polymerise the monomers, the impregnated wood is cured by heating it to a temperature in the range of from 70 to 140° C. The cured wood product has a relatively high polymer content (at least 68% based on dry wood content in the examples of WO 02/30638) and a relatively high density (at least 0.99 g/cc in the examples of WO 02/30638). A disadvantage of the impregnation method of WO 02/30638 is the high amount of furfuryl alcohol that is used, and resulting high costs of the method.

In order to use smaller amounts of furfuryl alcohol, a wood impregnation method is proposed in WO 2004/011216 wherein wood is impregnated with a polymerisable furfuryl alcohol monomer, a stabilising co-solvent and water as diluent and an initiator selected from an anhydride, an acid or a chloride. The co-solvent is removed from the impregnated wood before or after polymerisation of the furfuryl alcohol monomer. The co-solvent may be selected from acetone and low-temperature boiling alcohols such as methanol, ethanol or isopropanol. A disadvantage of the method disclosed in WO 2004/011216 is that a solvent removal step is required.

There is a need in the art for a lignocellulose preservative composition that overcomes the disadvantages of the prior art wood preservation compositions.

### SUMMARY OF THE INVENTION

It has now been found that a lignocellulose preservative composition comprising both pyrolysis oil and a polymerisable furan compound and a catalyst for polymerisation of the furan compound, has certain unexpected advantages over the prior art wood preservative compositions.

Accordingly, the present invention relates to a lignocellulose preservative composition comprising:
a) in the range of from 50 to 98 wt % of a pyrolysis oil obtainable by pyrolysis of lignocellulosic material;
b) a polymerisable furan compound; and
c) a catalyst for polymerising the furan compound in a catalytically effective amount.

The lignocellulose preservative composition according to the invention can advantageously be applied for preservation of wood and non-wood lignocellulosic material by first impregnating lignocellulosic material with the composition according to the invention and then causing polymerisation (curing) of the furan compound by heating the impregnated lignocellulosic material to a temperature in the range of from 70 to 200° C.

Accordingly, in a further aspect, the invention relates to a process for producing preserved lignocellulosic material comprising:
a) impregnating lignocellulosic material by immersing the lignocellulosic material in a composition as hereinbefore defined; and
b) polymerising the furan compound by heating the impregnated lignocellulosic material to a temperature in the range from 70 to 200° C.

An important advantage of the composition according to the invention is that if it is used to impregnate lignocellulosic material and the impregnated material is subsequently cured, the cured material has not the unpleasant odour that is typically for pyrolysis oil. Moreover, leaching of pyrolysis oil from the cured product is minimised. The impregnated and cured lignocellulosic material has improved properties compared to lignocellulosic material impregnated with pyrolysis oil only, in particular improved fungi resistance and a reduced moisture uptake. It has further been found that the use of the lignocellulose preservative composition according to the invention has certain advantages compared to the known use of a solution containing a polymerisable furfuryl alcohol monomer and a catalyst. In particular, less furan compound is needed to achieve comparable or improved fungi resistance and moisture resistance properties of the impregnated and cured material.

In a further aspect, the invention relates to preserved lignocellulosic material obtainable by the process as defined hereinbefore. In a final aspect, the invention relates to engineered wood or non-wood product, in particular fibre board or oriented strand board, comprising the preserved lignocellulosic material as hereinbefore defined, in particular preserved fibrous lignocellulosic material such as strands or fibres.

### DETAILED DESCRIPTION OF THE INVENTION

The lignocellulose preservative composition according to the invention comprises pyrolysis oil obtainable by pyrolysis of lignocellulosic material, a polymerisable furan compound and a catalyst that is able to polymerise the furan compound.

Pyrolysis is a known process wherein organic material is thermally decomposed without the participation of oxygen. Upon pyrolysis of organic materials a gaseous phase and a solid phase (char) is formed. Upon condensing the condensable part of the gaseous phase, a liquid phase, usually referred to as pyrolysis oil or bio oil is obtained. Pyrolysis reactions do not involve reactions with oxygen or water, but since working in a completely oxygen-free atmosphere is practically not possible, a small amount of oxidation occurs during pyrolysis.

Pyrolysis of lignocellulosic material such as for example wood or non-wood lignocellulosic material such as for example straw, bagasse or other plant residues, is known in the art. The liquid phase obtained upon rapidly cooling condensable gases is called pyrolysis oil or bio oil and typically is acidic. Lignocellulosic material may be pyrolysed by conventional, slow pyrolysis. In slow pyrolysis an equilibrium is reached resulting in approximately equal amounts of char, condensed gases (pyrolysis oil) and non-condensable gases. More recently, lignocellulosic material is often pyrolysed by means of so-called fast or flash pyrolysis. In fast or flash pyrolysis, the gaseous phase is condensed before an equilibrium stage is reached, resulting in a higher yield of pyrolysis oil with a different composition. Flash or fast pyrolysis typically comprises pyrolysis of finely comminuted material, typically with particle sizes in the order of a few mm. The particles are continuously moved during pyrolysis for example in a rotating bed, a moving bed or a fluidized bed reactor. Fast or flash pyrolysis oil is known in the art and for example described in more detail in WO 00/25996. Typically, pyrolysis oil from fast or flash hydrolysis comprises water, pyrolytic lignin, phenolic fragments, carboxylic acids such as acetic acid, formic acid, propionic acid and glycolic acid, aldehydes, furans, mono- and oligosaccharides, anhydrosugars, ketones, and alcohols such as acetol methanol and ethylene glycol.

The pyrolysis oil in the lignocellulose preservative composition according to the invention may be any pyrolysis oil obtainable from lignocellulosic material, i.e. pyrolysis oil obtained by slow, conventional pyrolysis or pyrolysis oil obtained by fast or flash pyrolysis. Preferably, the pyrolysis oil is pyrolysis oil obtainable from fast or flash pyrolysis of lignocellulosic material.

The lignocellulosic material from which the pyrolysis oil is obtained may be any suitable lignocellulosic material including wood and non-wood material such as straw, bagasse or other agricultural residues or lignin-rich waste streams from paper manufacturing processes. Preferably, the pyrolysis oil is obtained from wood, more preferably from wood that has not been treated with conventional wood preservatives such as creosote oil, pentachlorophenol or Wolman salts.

The composition according to the invention comprises in the range of from 50 to 98 wt % based on the total weight of the composition, preferably of from 60 to 95 wt %, more preferably of from 70 to 90 wt %, even more preferably of from 75 to 90 wt % pyrolysis oil. The composition further comprises a polymerisable furan compound and a catalyst that is able to polymerise the furan compound.

Examples of suitable polymerisable furan compound are disclosed in US2010/0062276. The polymerisable furan compound disclosed in US2010/0062276 are disclosed herein by reference. Preferably, the polymerisable furan compound is a hydroxymethyl furan such as for example furfuryl alcohol, 5-methyl-2-furfuryl alcohol, 3-hydroxymethyl-5-methyl-2-furfurylalcohol, 2,5-bis(hydroxymethyl)furan, 2,3,5-tris(hydroxymethyl)furan, hydroxymethylfurfural, 2,2′-(hydroxymethyl)difurylmethane, 2,2′,4,4′-(hydroxymethyl)difurylmethane or condensation products thereof. Other suitable polymerisable furan compounds include furfural, 2,5-furandicarboxylic acid and methoxymethylfurfural. Preferably, the polymerisable furan compound has not more than three furan units, more preferably not more than two furan units. A particularly preferred polymerisable furan compound is furfuryl alcohol.

The amount of furan compound in the composition may be up to 50 wt %. Preferably, the amount of furan compound is in the range of from 5 to 45 wt % based on the total weight of the composition, more preferably of from 10 to 40 wt %, even more preferably of from 10 to 25 wt %.

Catalysts capable of polymerising furan compounds are known in the art and include anhydrides, acids, chlorides, nitrates, sulphates, ammonium salts. Any suitable catalyst may be used. Preferably, the catalyst is acidic (Brønsted or Lewis acid). More preferably the catalyst is zinc chloride, citric acid, formic acid, a borate, maleic acid, malic acid, phtalic acid, maleic anhydride, phtalic anhydride, or a combination of two or more thereof. Preferably, the catalyst has cross-linking activity. An example of a preferred catalyst that is acidic and has cross-linking activity is maleic anhydride. The catalyst is present in a catalytically effective amount. Preferably, the catalyst is present in an amount in the range of from 1 to 30 wt % based on the weight of furan compound, more preferably of from 2 to 25 wt %, more preferably of from 3 to 20 wt %. The amount of catalyst based on the total weight of the composition is preferably in the range of from 0.1 to 5 wt %, more preferably of from 0.5 to 3 wt %.

The lignocellulose preservative composition preferably essentially consists of pyrolysis oil, polymerisable furan compound and the catalyst, i.e. in the absence of compounds other than contaminants in minor amounts.

The invention further relates to a process for producing preserved lignocellulosic material, in particular wood, wherein lignocellulosic material is impregnated with the composition according to the invention by immersing lignocellulosic material in the lignocellulose preservative composition according to the invention (impregnating step a)) and subsequently curing the thus-impregnated material by heating the impregnated material to a temperature in the range from 70 to 200° C. (curing step b)). In curing step b), the furan compound is polymerised.

The lignocellulosic material to be impregnated may be any suitable lignocellulosic material, including wood and non-wood lignocellulosic material. Preferably, the lignocellulosic material to be impregnated is wood, more preferably untreated wood, i.e. wood that is not coated or impregnated with a wood preservative composition such as for example creosote oil, pentachlorophenol, Wolman salts or a composition or compound other than a wood preservative composition.

Suitable non-wood lignocellulosic materials include, but are not limited to, straw, flax or hemp fibres, miscanthus, bagasse or corn stover. The lignocellulose material may be a lignin-rich waste product, for example a lignin-rich waste stream from a paper manufacturing process.

The lignocellulosic material to be treated may have any suitable shape and size, for example wooden parts to be used in the construction of further products such as for example furniture, flooring, building parts, window or door frames, outdoor items such as fences, garden furniture, railings, bridges, playground equipment, boat parts. The wood may also be small wood parts such as for example strands, flakes, fibres, particles or timber to be used in engineered wood products such as for example wood fibre boards, oriented strand boards, (glued) laminated timber, laminated veneer lumber.

Preferably, the lignocellulosic material to be impregnated has a moisture content of at most 50 wt %, more preferably a moisture content of at most 30 wt %, even more preferably in the range of from 10 to 30 wt %.

Impregnation step a) may be carried out in any suitable way. In order to facilitate impregnation of the composition, the lignocellulose material to be impregnated may be subjected to a sub-atmospheric pressure prior to immersing it in the preservative composition, preferably to a pressure in the range of from 10 to 300 mbar (absolute).

Impregnation step a) may be carried out at any suitable pressure. Preferably, step a) is carried out at a pressure in the range of from atmospheric up to 20 bar (absolute), more preferably in the range of from 3 to 10 bar (absolute). The impregnation may be carried out at any suitable temperature, preferably at a temperature in the range of from 25 to 90° C., more preferably of from 40 to 80° C.

Optionally, to control the amount of lignocellulose preservative composition impregnated, the impregnated material may be subjected to a pressure below atmospheric pressure, typically in the range of from 10 to 300 mbar (absolute), to allow excess amount of preservative composition to be removed prior to curing step b).

In curing step b), the impregnated material obtained in step a), preferably after removing excess preservative composition, is subjected to a heat treatment at a temperature in the range of from 70 to 200° C., preferably of from 100 to 180° C. The temperature in curing step b) is preferably higher than the temperature in impregnation step a).

In the process according to the invention, the amount of lignocellulose preservative composition in the cured material may be any suitable amount. Preferably, the amount is such that a weight increase in the range of from 25 to 500 kg per cubic metre lignocellulosic material, more preferably of from 100 to 300 kg per cubic metre lignocellulosic material, is obtained.

The invention further relates to preserved (i.e. impregnated and cured) lignocellulosic material obtainable by the process according to the invention. Such material appears to have improved resistance against fungi, less moisture uptake, less leaching of preservative composition and an improved odour compared to material impregnated with pyrolysis oil. Compared to lignocellulosic material impregnated with a solution containing a polymerisable furfuryl alcohol monomer followed by curing, the impregnated lignocellulosic material according to the invention has comparable or improved fungi resistance and comparable or improved moisture resistance properties, whilst less furan compound is needed.

The impregnated lignocellulosic material according to the invention may be wooden parts that may be used as such or in the construction of further products such as for example furniture, flooring, building parts, window or door frames, outdoor items such as fences, garden furniture, railings, bridges, playground equipment, boat parts.

Preserved lignocellulosic material according to the invention in the form of smaller parts, such as for example wood or non-wood strands, flakes, fibres, or particles can suitable be used in engineered wood or non-wood products such as fibre boards, oriented strand boards, (glued) laminated timber, laminated veneer lumber. In such engineered products, the preserved, i.e. impregnated and cured, lignocellulosic material according to the invention is mixed with a resin, preferably a thermoset resin, to obtain a mixture of preserved lignocellulosic material and resin. The mixture thus-obtained is heated to cure the resin and to form the engineered wood or non-wood product. In a final aspect, the invention therefore relates to an engineered wood or non-wood product comprising preserved lignocellulosic material according to the invention.

The invention will be further illustrated by means of the following non-limiting examples.

### EXAMPLES

### Example 1 (Invention)

### Wood Impregnation

Dried pine wood samples (Pinus sylvestris L.) with dimensions of 100×10×10 mm and a moisture content of 10 wt % were placed in a closed 0.9 L stainless steel reactor and subjected to vacuum (0.3 bar (absolute)) during 30 minutes. During these 30 minutes, the temperature was raised to 60° C. The reactor was then filled with 0.8 L of a preheated (60° C.) wood preservative composition comprising 80 wt % pyrolysis oil obtained from flash pyrolysis of softwood, 19 wt % furfuryl alcohol and 1 wt % maleic anhydride, brought at a pressure of 3 bar (absolute) by adding nitrogen and maintained at this pressure during one hour. The reactor was then subjected to vacuum (pressure of 0.3 bar (absolute)) during 30 minutes in order to remove excess wood preservative composition from the sample.

### Curing

The impregnated wood samples thus obtained were subsequently cured by subjecting them to a curing temperature of 160° C. during 24 hours.

### Example 2 (Comparison)

Dried pine wood samples were impregnated as described in EXAMPLE 1, but now with 0.8 L of a wood preservative composition consisting of 100 wt % pyrolysis oil obtained from fast pyrolysis of softwood. The impregnated wood samples thus obtained were dried at a temperature of 105° C. until the sample weight remained constant.

### Example 3 (Comparison)

Dried pine wood samples were impregnated as described in EXAMPLE 1, but now with 0.8 L of a wood preservative composition comprising 19 wt % furfuryl alcohol, 1 wt % maleic anhydride and 80 wt % demineralised water. The impregnated wood samples thus obtained were subsequently cured by subjecting them to a curing temperature of 160° C. during 24 hours.

### Example 4

The impregnated and cured or dried wood samples obtained in EXAMPLES 1 to 3, were analysed as follows.

### Water Uptake

The water uptake at 90% relative humidity at 20° C., was determined. This was done by measuring the weight increase of 10 specimen of impregnated and cured or dried wood samples, after the samples had reached an equilibrium moisture content.

### Leaching

Leaching of wood preservative composition from the dried or cured samples was determined by placing the samples under 125 ml demineralised water of 50° C. during 28 days. After 28 days, the samples were dried until the weight remained constant.

### Odour

The wood samples obtained in EXAMPLE 2 (pyrolysis oil impregnation) have a strong smell that is typical for pyrolysis oil (resembling the smell of burnt wood). The wood samples obtained in EXAMPLE 1 (invention) have hardly any off smell. Also the samples obtained in EXAMPLE 3 (polymerised furfuryl alcohol) have hardly any off smell.

### Resistance to Microbial Decay (Fungi)

An agar plate inoculated with monocultures of Coniophora puteana (brown rot fungi) and Trametes versicolor (white rot fungi), respectively, was placed in a test container conditioned at a relative humidity of 65% and a temperature of 22° C. After complete coverage of the agar plate with fungi, sterilised wood blocks (dimensions 30×10×10 mm) were placed on agar plate on top of the fungi.

At regular times the wood blocks were visually inspected. After seven weeks the weight loss was determined for the blocks placed on the brown rot fungi and after eleven weeks for the blocks placed on the white rot fungi. The weight of the blocks was measured after removing the attached microbial biomass from the blocks and drying the blocks at 105° C. until the weight remained constant.

### Results

In the Table, the results of the analyses are shown.

TABLE

| | EXAMPLE 1 | EXAMPLE 2 | EXAMPLE 3 |
|---|---|---|---|
| | invention | comparison | comparison |
| Weight gain (%) | 39 | 54 | 20 |
| Moisture uptake | 8.6 | 10.3 | 10.8 |
| 90% RH | | | |
| Leaching (% of | 16.2 | 50.3 | 6.2 |
| amount of | | | |
| composition | | | |
| impregnated)) | | | |
| Odour | negligible | strong | negligible |
| Weight loss (%) | 1.4 | 5.9 | 6.5 |
| brown rot | | | |
| Weight loss (%) | 3.7 | 5.7 | 1.6 |
| white rot | | | |

1-15. (canceled)

16. A lignocellulose preservative composition, comprising:
(a) 50 to 98 wt % of a pyrolysis oil obtainable by pyrolysis of lignocellulosic material;
(b) a polymerisable furan compound; and
(c) a catalytically effective amount a catalyst for polymerising the furan compound.

17. The lignocellulose preservative composition according to claim 16, wherein the catalyst is selected from the group consisting of anhydrides, acids, chlorides and combinations thereof.

18. The lignocellulose preservative composition according to claim 16, wherein the polymerisable furan compound is furfuryl alcohol.

19. The lignocellulose preservative composition according to claim 16, comprising catalyst from 1 to 30 wt %, based on the weight of furan compound.

20. The lignocellulose preservative composition according to claim 16, comprising 70 to 90 wt % of the pyrolysis oil.

21. A lignocellulose preservative composition according to claim 16, comprising 10 to 40 wt % furan compound, based on the total weight of the composition.

22. A lignocellulose preservative composition according to claim 16, wherein the pyrolysis oil is obtainable by fast or flash pyrolysis of lignocellulosic material.

23. A process for producing preserved lignocellulosic material, comprising:
(a) immersing the lignocellulosic material in a composition according to claim 16 to obtain a impregnated lignocellulosic material; and
(b) heating the impregnated lignocellulosic material to a temperature in the range from 70 to 200° C. thereby polymerising the furan compound.

24. The process according to claim 23, wherein the lignocellulosic material is wood.

25. The process according to claim 24, wherein the wood is untreated wood.

26. The process according to claim 23, wherein the immersing is carried out at a temperature between 25 to 90° C.

27. The process according to claim 24, wherein the immersing is carried out at a temperature between 25 to 90° C.

28. The process according to claim 23, wherein the immersing is carried out at a pressure between atmospheric pressure to 20 bar (absolute).

29. The process according to claim 24, wherein the immersing is carried out at a pressure between atmospheric pressure to 20 bar (absolute).

30. The process according to claim 23, wherein the lignocellulosic material has a moisture content of at most 30 wt %.

31. A process according to claim 24, wherein the lignocellulosic material has a moisture content of at most 30 wt %.

32. A preserved lignocellulosic material obtainable by a process according to claim 23.

33. A preserved lignocellulosic material obtainable by a process according to claim 24.

34. Engineered wood or non-wood product comprising preserved lignocellulosic material according to claim 32.

35. Engineered wood or non-wood product comprising preserved lignocellulosic material according to claim 33.
